(19) United States
(12) Patent Application Publication
(10) Pub. No.: US 2012/0197708 A1
(43) Pub. Date: Aug. 2, 2012

(54) SYSTEMS AND METHODS FOR SOCIAL NETWORKING MECHANISMS FOR POWERED CARDS AND DEVICES

(76) Inventors: Jeffrey D. Mullen, Pittsburgh, PA (US); Philip W. Yen, Cupertino, CA (US)

(21) Appl. No.: 13/158,458

(22) Filed: Jun. 13, 2011

Related U.S. Application Data
(60) Provisional application No. 61/438,239, filed on Jan. 31, 2011.

(51) Int. Cl. G06Q 30/00

(52) U.S. Cl. 705/14.35; 705/14.1

(57) ABSTRACT

A card may receive and store one or more coupon offers (e.g., promotions, awards, rewards, or incentives). Coupon offers, associated details, and associated coupon detail updates may be displayed onto one or more displays of a card. A cardholder may monitor, purchase, and redeem such coupon offers automatically and/or by activating manual inputs (e.g., buttons) on the card. Cardholders and one or more components of a payment monitoring system may encourage increased patronage for merchants, since coupon redemption values may be qualified and/or increased through increased interaction of the members. Such increased interaction of the members may be monitored by each member through coupon detail updates displayed on each member's card.

### CROSS-REFERENCE TO RELATED APPLICATION

This application claims the benefit of U.S. Provisional Patent Application No. 61/438,239, titled “SYSTEMS AND METHODS FOR SOCIAL NETWORKING MECHANISMS FOR POWERED CARDS AND DEVICES,” filed Jan. 31, 2011 (Attorney Docket No. D/058 PROV), which is hereby incorporated by reference herein in its entirety.

### BACKGROUND OF THE INVENTION

This invention relates to magnetic cards and devices and related systems.

### SUMMARY OF THE INVENTION

A card may include a dynamic magnetic communications device, which may take the form of a magnetic encoder or a magnetic emulator. A magnetic encoder, for example, may be utilized to modify information that is located on a magnetic medium, such that a magnetic stripe reader may then be utilized to read the modified magnetic information from the magnetic medium. A magnetic emulator, for example, may be provided to generate electromagnetic fields that directly communicate data to a read-head of a magnetic stripe reader. A magnetic emulator, for example, may communicate data serially to a read-head of the magnetic stripe reader. A magnetic emulator, for example, may communicate data in parallel to a read-head of the magnetic stripe reader.

All, or substantially all, of the front surface, as well as the rear surface, of a card may be implemented as a display (e.g., bi-stable, non bi-stable, LCD, or electrochromic display). Electrodes of a display may be coupled to one or more touch sensors, such that a display may be sensitive to touch (e.g., using a finger or a pointing device) and may be further sensitive to a location of the touch. The display may be sensitive, for example, to objects that come within a proximity of the display without actually touching the display.

A dynamic magnetic stripe communications device may be implemented on a multiple layer board (e.g., a two-layer flexible printed circuit board). A coil for each track of information that is to be communicated by the dynamic magnetic stripe communications device may then be provided by including wire segments on each layer and interconnecting the wire segments through layer interconnections to create a coil. For example, a dynamic magnetic stripe communications device may include two coils such that two tracks of information may be communicated to two different read-heads included in a read-head housing of a magnetic stripe reader. A dynamic magnetic communications device may include, for example, three coils such that three tracks of information may be communicated to three different read-heads included in a read-head housing of a magnetic stripe reader.

Input and/or output devices may be included on a card, for example, to facilitate data exchange with the card. For example, an integrated circuit (IC) may be included on a card and exposed from the surface of the card. Such a chip (e.g., an EMV chip) may communicate information to a chip reader (e.g., an EMV chip reader). An RFID antenna or module may be included on a card, for example, to send and/or receive information between an RFID writer/reader and the RFID included on the card.

One or more detectors may be provided, for example, to sense the presence of an external object, such as a person or device, which in turn, may trigger the initiation of a communication sequence with the external object. The sensed presence of the external object may then be communicated to a card, which in turn may direct the exchange of information between a card and the external object. Accordingly, timing aspects of the information exchange between a card and the various I/O devices implemented on a card may also be determined by a card.

The sensed presence of the external object or device may include the type of object or device that is detected and, therefore, may then determine the type of communication that is to be used with the detected object or device. For example, a detected object may include a determination that the object is a read-head housing of a magnetic stripe reader. Such an identifying detection, for example, may activate a dynamic magnetic stripe communications device so that information is communicated (e.g., electromagnetically communicated) to the read-head of the magnetic stripe reader.

A card may include one or more processors, one or more buttons, memory, and one or more displays.

The processor may, for example, process information that may be associated with an incentive, award, reward and/or promotion (e.g., a coupon) and store such information within a memory of a card. Accordingly, for example, a user may provide a manual input to the card (e.g., by pressing a button) to instantly buy, redeem, or utilize a coupon that may have been communicated to a card and whose details may be displayed by a display of the card. A user may, for example, press a button on a card to purchase and redeem a coupon that may be offered for purchase. A user may, for example, cause information about the purchase and the redemption of the coupon to be provided by the display of a card after a button is pressed on the card. A user may, for example, automatically receive (e.g., via email or mobile text message) information about the purchase and the redemption of a coupon.

A cardholder may, for example, be a registered subscriber to a coupon scheme that may be offered by a coupon company. A cardholder, for example, may have agreed to allow a purchase price of a coupon generated by such a coupon promotion and distribution scheme to be automatically deducted (e.g., charged) from an account (e.g., a debit or credit account) that may be associated with the cardholder's card.

A cardholder may, for example, receive notice of a coupon offer being generated by a merchant when the cardholder's card is passed within a communication distance of a merchant's communication device (e.g., an RFID device). Coupons may, for example, be passed to one or more cards via card-to-card communications (e.g., via RFID, IR, pulsed light, or touch sensitive communications).

Alternately, a cardholder may provide manual input (e.g., press a button) to the card to obtain a notice of a coupon offer. A cardholder may enable a card (e.g., via a mobility device) to access a network (e.g., the internet) for any notices of coupon offers that may exist. The notices, for example, may be displayed on a display of the device. The cardholder may, for example, observe details associated with the coupon offer as they are displayed by the same, or different, display of the device.

A coupon may be shared via social networks and/or social games. For example, coupons may be shared (e.g., propagated amongst one or more members of a social group) via a network connection (e.g., internet or Bluetooth enabled local network). Text messaging services between one or more cards (e.g., mobile devices) may, for example, be utilized to share coupons. Social networking games may, for example, provide for propagation of coupons based upon interaction amongst its membership (e.g., games may be hosted by a coupon company where coupon distribution may be based at least in part by a quantity and/or quality of participation occurring amongst the membership of a socially networked group).

A card (e.g., a mobile device) may include sensors that may be sensitive to pulses of light. Upon receipt of a series of pulses of light, for example, the card or mobile device may interpret the pulses of light as bits of data. Such bits of data, for example, may be representative of coupon information that may be offered by a particular merchant, coupon company and/or card issuer.

Accordingly, for example, a cardholder may press his or her card against a device (e.g., a TV display or cash register monitor) at a merchant's place of business. A programming portion of the display may provide a series of light pulses that may be detected by the cardholder's card as a series of data bits that may be associated, for example, with a coupon offer from the merchant, card issuer and/or coupon company. Once the data bits are downloaded into the cardholder's card, a processor of the card may construe the data bits as a coupon message (e.g., an offer for a coupon) and display the coupon offer onto a display of the card.

A cardholder may, for example, press a button on the card in response to a coupon offer being displayed by a display of the card. Such a button press may acknowledge the cardholder's agreement to purchase the coupon. Alternatively, another button on the card may be pressed to signify the cardholder's rejection of the coupon offer.

Upon acceptance of the coupon offer, for example, a cardholder's account (e.g., debit or credit account) that may be associated with the cardholder's card may be debited for a purchase price of the coupon. The cardholder may, for example, proceed with a purchase transaction at a merchant's place of business (or from a merchant's website) and may redeem any and all discounts offered by such a coupon.

A cardholder may, for example, press a button on a card in response to a message displayed on a display of the cardholder's card. For example, prior to completion of a transaction, a merchant's point-of-sale device may communicate with a cardholder's card (e.g., via RFID, IR, pulsed light, and/or electromagnetic communications) to cause the card to display a message to the cardholder. Such a message may, for example, query the cardholder to provide permission (e.g., via a press of a button) or to decline to provide permission (e.g., via a press of another button) for an opportunity to share certain of the cardholder's information (e.g., personal, demographic, or socio-economic information) with the merchant and/or the merchant's affiliates.

After a transaction is complete, for example, a cardholder's card may be updated with transaction information. For example, a merchant's point-of-sale device may communicate coupon redemption information to the cardholder's card. A cardholder's card, for example, may be updated with information that a certain coupon has been redeemed or a partial redemption has occurred. Alternately, a cardholder's card may, for example, be updated with information that an amount of credit may be kept on the card for the next purchase at the same merchant.

A coupon company (e.g., a card issuer) may, for example, settle with a merchant for coupons honored by the merchant. An amount equal to the discount offered by the coupon, for example, may be credited back to the cardholder's account once settlement between the coupon company and the merchant completes. The amount credited back to a cardholder's account may, for example, be greater than the purchase price of the coupon. Merchants may, for example, combine the coupon purchased by the cardholder with an offer of a coupon for future purchases by that same cardholder.

Coupon companies may, for example, make coupons available for use at a merchant's place of business. Coupon companies may, for example, make coupons available for use at a merchant's place of business, but only if a minimum number of cardholders accept and purchase the coupon. For example, a group of cardholders (e.g., a socially networked group) may be incentivized to encourage one another to shop at a particular merchant in hopes of receiving a coupon offer from the merchant. Accordingly, for example, each respective cardholder may encourage one or more other cardholders to patronize a particular merchant, so as to increase the merchant's volume of potential sales, but also to increase a likelihood that each of the patronizing cardholders receive a coupon.

A coupon company (e.g., a card issuer) may, for example, provide incentives for card-based coupon holders to pool their purchases at a particular merchant's place of business or at the places of business for a group of merchants. Accordingly, for example, a group of cardholders may be further incentivized to patronize one or more merchants.

Each member of a socially networked group may, for example, be identified with a particular code or a particular bit sequence. Such a code may be communicated to a merchant's point-of-sale device, for example, as electromagnetic information (e.g., discretionary data) by a dynamic magnetic stripe communications device of a cardholder's card. A tracking system (e.g., a networked combination of a merchant's point-of-sale device, a card issuer, and a coupon company) may, for example, track each transaction that may be conducted by each member of a group (e.g., a socially networked group). After a threshold number of purchases (or purchased value) is transacted by the socially networked group, for example, the merchant may cause a coupon offer to be generated by a coupon company. Such a coupon offer may, for example, be disseminated to each member of the socially networked group in gratitude for patronage to the merchant.

A discount offered by a particular merchant may, for example, depend upon the number of cardholders that may be attracted to the merchant. Accordingly, for example, a redemption value of a coupon may depend upon a number of customers wishing to redeem such a coupon. A minimum discount may, for example, be guaranteed by the coupon company, so that patronizing cardholders may take comfort in at least a minimum discount that may be offered by the coupon company to all qualifying cardholders.

A cardholder may provide manual input (e.g., press a button) on a card to, for example, request from a merchant that a coupon be provided to the cardholder for future purchases. For example, a button press may cause additional data (e.g., discretionary data representative of a coupon request) to be generated when a dynamic magnetic stripe communications device of a card communicates to a read-head of a magnetic stripe reader during a transaction at the merchant's place of business.

Such additional data may, for example, cause a coupon offer to be generated by the merchant and provided to the cardholder at some point during or after the transaction. The merchant may alternately accumulate such coupon requests. After a minimum threshold of coupon requests are received by the merchant, for example, the coupon company may negotiate with the merchant for coupon distribution. Upon distribution of requested coupons, a cardholder recipient of the coupons may agree to redeem a minimum percentage of requested coupons over a given amount of time. A minimum percentage of requested coupons may, for example, not be redeemed within a given time period. Accordingly, for example, a non-redemption penalty may be assessed.

Coupons, for example, may be generated and distributed in physical form (e.g., paper form). Coupons, for example, may be generated and distributed in electronic form (e.g., eCoupons). Electronic distribution of eCoupons may, for example, occur in any number of electronic formats. For example, eCoupons may be distributed electronically (e.g., via email or merchant websites) to patrons who have previously registered with coupon companies. Alternately, eCoupons may be downloaded into a cardholder's card, for example, using pulses of light that may be construed by a processor on the card as eCoupon data. Electronic coupons may be transferred from card to card via, for example, touch sensitive displays and touch simulating displays of the respective cards.

Requesting, generating, distributing and/or using eCoupons may, for example, be conducted at the point of sale. A cardholder may press a button on his or her card, for example, to communicate information (e.g., electromagnetic information) that indicates the cardholder's desire to receive a coupon. The transaction may, for example, qualify the patron to receive a coupon (e.g., the coupon request may represent the last of a minimum number of coupon requests required to qualify patrons to receive qualified coupons).

Such a qualification, for example, may be signaled to the merchant conducting the transaction via the merchant's point-of-sale terminal. Once qualified, a cardholder may press his or her card against the merchant's point-of-sale terminal to receive data indicative of the coupon (e.g., the point-of-sale terminal may communicate data via a series of light pulses that may be received and construed by a processor on the card as coupon data).

A cardholder may, for example, request a coupon from a merchant other than the merchant conducting the transaction. For example, a cardholder may request a coupon from a merchant in the same or similar category as the transacting merchant. For example, a cardholder purchasing gas from a gas station may request a coupon from the gas station for a discounted oil change to be used in the future at a different merchant's place of business.

A card may, for example, collect and store one or more coupons for future use. One or more buttons on a card may be used, for example, to request redemption of the corresponding one or more coupons that may be stored within the card. A single button, for example, may be pressed any number of times to cycle through a list of coupons that may be stored within the card. A display of the card, for example, may be used to display indicia associated with each coupon that may be stored within the card. A second display of the card, for example, may be used to display details associated with each coupon that may be stored within the card.

Coupons may, for example, have expiration dates associated with them. Accordingly, for example, a processor of a card may track each expiration date of each coupon stored within a card and may purge an expired coupon from a card's memory. Additionally, a card's display may provide indicia to a user of the card that one or more coupons are scheduled to expire, thereby prompting the cardholder to make use of the one or more coupons before they are no longer valid for use.

Coupon usage may, for example, result in an instantaneous credit to the cardholder. For example, a merchant transaction system may intercept a payment authorization message to effect an instantaneous discount on the purchase price at the point of sale. Alternately, for example, a batch process settlement may be implemented with a coupon company on a deferred basis, whereby the cardholder may receive a credit on the cardholder's next account statement.

A powered card, such as a powered payment card, or other device may include a button associated with a deal of the day. A user may receive information directly to the card, or via another device, indicative of that deal of the day. For example, a user may receive on a mobile telephonic device or card a text message, email, or information update on an application indicative of a deal of the day. A deal of the day may be a particular discount at a particular merchant, group of merchants, and/or type of merchant. The discount may be for a particular type of purchase (e.g., the purchase of a particular item or service). A user may make an in-store purchase covered by the deal-of-the-day. At checkout, the user may select an option on the card, or other device, indicative of the user's desire to obtain the deal of the day.

Information associated with the selection may be communicated to a card reader. For example, information indicative of the selection may be included in the magnetic stripe data provided by a dynamic magnetic stripe communication device on the card. As per another example, information indicative of the selection may be included in RF data provided by an RFID antenna on a mobile telephonic phone to an RF card reader.

Processing may receive and process the data to determine the user was desirous of utilizing the deal of the day feature. In doing so, the user may be provided with the deal and the transaction may be processed in accordance with the parameters of the deal. The processing may also determine if all, or part of, the transaction qualifies for the deal of the day.

A deal of the day may be valid, for example, for a period of time (e.g., approximately 20-52 hours).

A deal of the day may be changed periodically (e.g., every day). Multiple deals of the day may be provided so that a user includes a larger deal of the day opportunities. For example, different deals of the day may be provided for different merchant types. For example, one gas station may have a deal of the day one day while another gas station may have a deal of the day another day.

The location within which a user resides may be utilized to determine the deal of the day for that user. The location of a user's last or previous purchase may also be utilized, at least in part, to determine a future deal of the day.

A user may utilize a web browser to visit a site and may, on that site, select, each day, a deal of the day to associate with his/her card or device. Accordingly, a user may be provided with multiple deals of the day and may, each day, select one deal of the day. These various deals of the day may change periodically. The user may also select a deal of the day from multiple deals of the day by pressing a button on a card, or other device, and uploading information from that card, or device. Such information may be communicated, for example, from a mobile telephonic chip and antenna provided in the device.

A deal of the day may be a one-time-use deal of the day or a multiple-time-use deal of the day. A cost may be associated with utilizing a deal of the day. A deal of the day may be processed at authorization or at settlement. A deal of the day may be applied to a transaction after the transaction has settled. For example, a deal of the day may be processed by a card issuer (e.g., credit card issuer) after that credit card transaction is settled and hits the user's credit card statement.

The card issuer may then, in turn, obtain payment from the provider of the deal of the day service or the merchant that received the deal of the day. The deal of the day service provider may, in turn, for example, then charge an amount to the merchant.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is an illustration of a card constructed in accordance with the principles of the present invention;

FIG. 2 is an illustration of a card constructed in accordance with the principles of the present invention;

FIG. 3 is an illustration of a card constructed in accordance with the principles of the present invention;

FIG. 4 is an illustration of a system constructed in accordance with the principles of the present invention;

FIG. 5 is an illustration of a card constructed in accordance with the principles of the present invention;

FIG. 6 is an illustration of a card constructed in accordance with the principles of the present invention;

FIG. 7 is an illustration of a process flow chart constructed in accordance with the principles of the present invention;

FIG. 8 is an illustration of a process flow chart constructed in accordance with the principles of the present invention;

FIG. 9 is an illustration of a process flow chart constructed in accordance with the principles of the present invention;

FIG. 10 is an illustration of a card constructed in accordance with the principles of the present invention; and

FIG. 11 is an illustration of a mobile device constructed in accordance with the principles of the present invention.

### DETAILED DESCRIPTION OF THE INVENTION

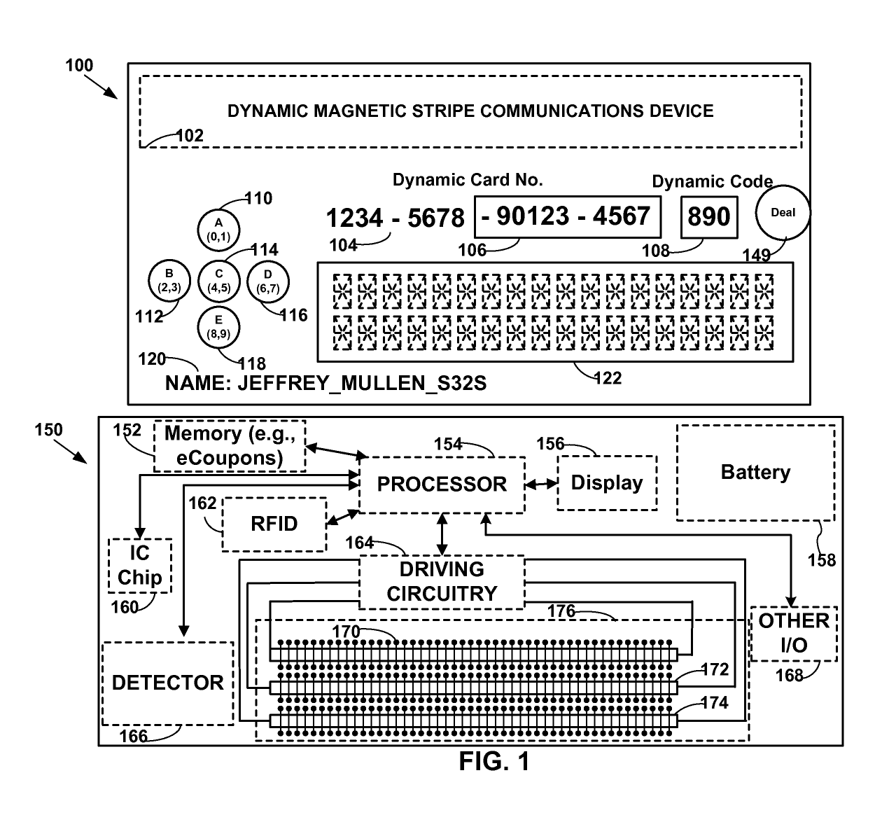

FIG. 1 shows card 100 that may include, for example, a dynamic number that may be entirely, or partially, displayed using a display (e.g., display 106). A dynamic number may include a permanent portion such as, for example, permanent portion 104 and a dynamic portion such as, for example, dynamic portion 106. Card 100 may include a dynamic number having permanent portion 104 and permanent portion 104 may be incorporated on card 100 so as to be visible to an observer of card 100. For example, labeling techniques, such as printing, embossing, laser etching, etc., may be utilized to visibly implement permanent portion 104.

Card 100 may include a second dynamic number that may be entirely, or partially, displayed via a second display (e.g., display 108). Display 108 may be utilized, for example, to display a dynamic code such as a dynamic security code. Card 100 may also include third display 122 that may be used to display graphical information, such as logos and barcodes. Third display 122 may also be utilized to display multiple rows and/or columns of textual and/or graphical information. For example, display 122 may be utilized to display information that is indicative of data (e.g., eCoupon data) that may be stored within a memory of card 100.

Persons skilled in the art will appreciate that any one or more of displays 106, 108, and/or 122 may be implemented as a bi-stable display. For example, information provided on displays 106, 108, and/or 122 may be stable in at least two different states (e.g., a powered-on state and a powered-off state). Any one or more of displays 106, 108, and/or 122 may be implemented as a non-bi-stable display. For example, the display is stable in response to operational power that is applied to the non-bi-stable display. Other display types, such as LCD or electro-chromic, may be provided as well.

Other permanent information, such as permanent information 120, may be included within card 100, which may include user specific information, such as the cardholder's name or username. Permanent information 120 may, for example, include information that is specific to card 100 (e.g., a card issue date and/or a card expiration date). Information 120 may represent, for example, information that includes information that is both specific to the cardholder, as well as information that is specific to card 100.

Card 100 may accept user input data via any one or more data input devices, such as buttons 110-118. Buttons 110-118 may be included to accept data entry through mechanical distortion, contact, or proximity. Buttons 110-118 may be responsive to, for example, induced changes and/or deviations in light intensity, pressure magnitude, or electric and/or magnetic field strength. Such information exchange may then be determined and processed by a processor of card 100 as data input.

For example, one or more buttons 110-118 may be activated to display indicia on a display (e.g., display 122) that may be associated with one or more corresponding eCoupons that may be stored within a memory of card 100. Alternately, for example, a single button (e.g., button 110) may be pressed multiple times to sequentially display data that may be associated with one or more eCoupons. Other buttons, for example, may be pressed to obtain details about each eCoupon that may be stored within a memory of card 100. Persons skilled in the art will appreciate that eCoupons may represent any promotion, incentive, award, and/or reward that may be offered by any merchant and/or any coupon company.

Button 149 may be provided and may be associated with, for example, a deal of a day feature. Periodically (e.g., every day), a user may be provided with a different deal of the day. The user may determine the deal of the day by, for example, receiving an update to his/her mobile telephonic device and/or card. The user may also log into a website that may provide the user with the user's deal of the day.

The user may press button 149 to utilize the deal of the day. The deal of the day, for example, may be utilized at any merchant, a particular merchant, a particular type of merchant, or a particular group of merchants. For example, a deal of the day may be to purchase a particular item at a particular merchant for a particular price. As per another example, a deal of the day may be to add a cost of $1 to any order online to receive free insurance on that item where the insurance would otherwise cost more than $1. Information indicative of a user's desire to utilize a deal of a day may be, for example, communicated from a card or other device (e.g., a mobile telephonic device) to a card reader and/or a remote server.

Persons skilled in the art will appreciate that a physical payment card may be provided as a virtual payment card on a display of any device, such as a mobile telephonic device or personal computing device. A button on a physical payment card may be a button on any device, such as a mobile telephonic device or personal computing device. Accordingly, for example, a device (e.g., a cell phone) may receive manual input from a manual user interface (e.g., a virtual button on a capacitive touch screen) and communicate information indicative of the selection (e.g., a selection of a deal of the day) to another device (e.g., a payment terminal such as a card reader) via a communications device (e.g., an RF-based communications device).

FIG. 1 shows architecture 150, which may include one or more processors 154. One or more processors 154 may be configured to utilize external memory 152, internal memory, or a combination of external memory 152 and internal memory for dynamically storing information, such as executable machine language, related dynamic machine data, and user input data values.

One or more of the components shown in architecture 150 may be configured to transmit information to processor 154 and/or may be configured to receive information as transmitted by processor 154. For example, one or more displays 156 may be coupled to receive data from processor 154. The data received from processor 154 may include, for example, at least a portion of dynamic numbers and/or dynamic codes. The data to be displayed on the display may be displayed on one or more displays 156.

One or more displays 156 may be, for example, touch sensitive and/or proximity sensitive. For example, objects such as fingers, pointing devices, etc., may be brought into contact with displays 156, or into proximity with displays 156. Detection of object proximity or object contact with displays 156 may be effective to perform any type of function (e.g., transmit data to processor 154). Displays 156 may have multiple locations that are able to be determined as being touched, or determined as being in proximity to an object.

Input and/or output devices may be implemented within architecture 150. For example, integrated circuit (IC) chip 160 (e.g., an EMV chip) may be included within architecture 150, that may communicate information to a chip reader (e.g., an EMV chip reader). Radio frequency identification (RFID) module 162 may be included within architecture 150 to enable the exchange of information between an RFID reader/writer and architecture 150.

Other input and/or output devices 168 may be included within architecture 150, for example, to provide any number of input and/or output capabilities on a card (e.g., card 100 of FIG. 1). For example, other input and/or output devices 168 may include an audio device capable of receiving and/or transmitting audible information. Other input and/or output devices 168 may include a Wi-Fi device, such that a card (e.g., card 100 of FIG. 1) may access an open network (e.g., the Internet).

Other input and/or output devices 168 may include a device that exchanges analog and/or digital data using a visible data carrier. For example, light pulses may be received by other input and/or output 168 and may be construed as data indicative of eCoupons and associated eCoupon details that may be stored within memory 152. Other input and/or output devices 168 may include a device, for example, that is sensitive to a non-visible data carrier, such as an infrared data carrier or electromagnetic data carrier. Other input and/or output devices 168 may include a device, for example, that simulates a touch or proximity of a pointing device (e.g., a human finger or stylus). Such a simulation may, for example, be detected by a touch sensitive display as information.

Persons skilled in the art will appreciate that a card (e.g., card 100 of FIG. 1) may, for example, be a self-contained device that derives its own operational power from one or more batteries 158. Furthermore, one or more batteries 158 may be included, for example, to provide operational power to a card for a period of time (e.g., approximately 2-4 years). One or more batteries 158 may be included, for example, as rechargeable batteries.

A dynamic magnetic stripe communications device may be included on a card (e.g., card 100 of FIG. 1) to communicate information to, for example, a read-head of a magnetic stripe reader via, for example, electromagnetic signals. For example, electromagnetic field generators 170-174 may be included to communicate one or more tracks of electromagnetic data to read-heads of a magnetic stripe reader. Electromagnetic field generators 170-174 may include, for example, a series of electromagnetic elements, where each electromagnetic element may be implemented as a coil wrapped around one or more materials (e.g., a magnetic material and/or a non-magnetic material). Additional materials may be placed outside the coil (e.g., a magnetic material and/or a non-magnetic material).

Electrical excitation by processor 154 of one or more coils of one or more electromagnetic elements via, for example, driving circuitry 164 may be effective to generate electromagnetic fields from one or more electromagnetic elements. One or more electromagnetic field generators 170-174 may be utilized to communicate electromagnetic information to, for example, one or more read-heads of a magnetic stripe reader.

Timing aspects of information exchange between a card and the various input and/or output devices implemented on a card may be determined by a processor of the card. Detector 166 may be utilized, for example, to sense the proximity and/or actual contact, of an external device, which in turn, may trigger the initiation of a communication sequence.

The sensed presence and/or touch of the external device may then be communicated to a controller (e.g., processor 154), which in turn may direct the exchange of information between a card (e.g., card 100 of FIG. 1) and the external device. The sensed presence and/or touch of the external device may be effective to, for example, determine the type of device or object detected.

For example, the detection may include the detection of a read-head of a magnetic stripe reader.

In response, processor 154 may activate one or more electromagnetic field generators 170-174 to initiate a communications sequence with, for example, one or more read-heads of a magnetic stripe reader. The timing relationships associated with communications between one or more electromagnetic field generators 170-174 and one or more read-heads of a magnetic stripe reader may be provided through use of the detection of the magnetic stripe reader.

Persons skilled in the art will appreciate that processor 154 may provide user-specific and/or card-specific information through utilization of any one or more buttons (e.g., buttons 110-118 of card 100 of FIG. 1), RFID 162, IC chip 160, electromagnetic field generators 170-174, and other input and/or output devices 168.

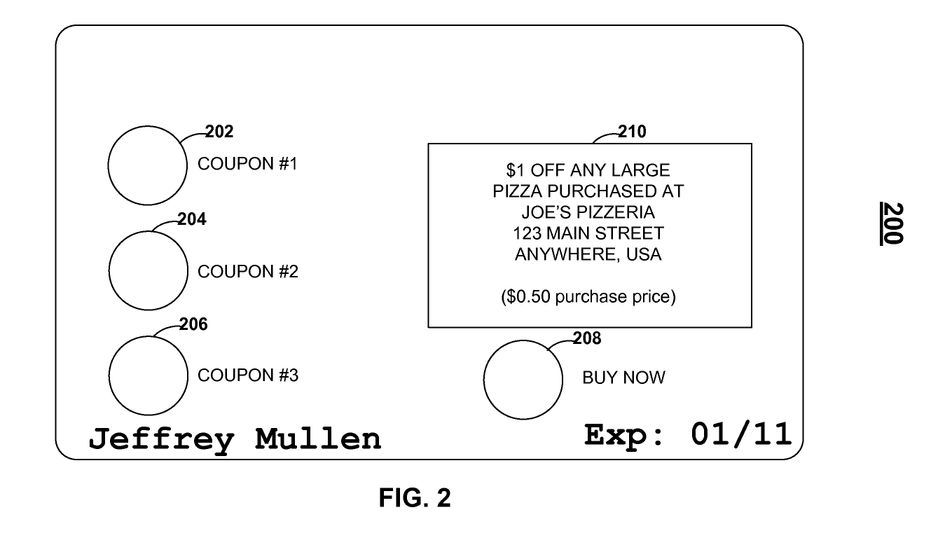

FIG. 2 shows card 200. Card 200 may include, for example, one or more buttons 202-208 and a display 210. A user of card 200 may, for example, select any of buttons 202-206 to display information onto display 208 that may be indicative of coupon information. A user may, for example, select button 202 to display a coupon that may be available for purchase. A user of card 200 may, for example, select button 208 to purchase the coupon displayed within display 210.

For example, the coupon displayed within display 210 may be selected for purchase if the user selects button 208 while the coupon is being displayed. Settlement of the purchase price of the coupon may be delayed, for example, until the user swipes card 200 through any magnetic stripe reader. In so doing, settlement data associated with the purchase of the coupon displayed within display 210 may be stored within card 200 until such time that card 200 is swiped during a subsequent transaction. Accordingly, for example, settlement data associated with the purchase of the coupon displayed within display 210 may be communicated at the same time that data associated with the subsequent transaction may be communicated.

A user may purchase a coupon and redeem the coupon in a single transaction. For example, a user who wishes to make a purchase with a coupon that may be honored at a merchant's place of business may press button 208 and swipe card 200 at the merchant's point-of-sale device. The purchase price of the coupon may, for example, be reconciled against the redemption value of the coupon and the difference may be immediately applied to the purchased goods. For example, a user redeeming a $1 off coupon whose purchase price is $0.50, receives a discount of $0.50 on a purchase applied against the coupon. The merchant's (e.g., Joe's Pizzeria) point-of-sale system may intercept a payment authorization message resulting from a card swipe and may immediately deduct the discount from the purchase price of the goods (e.g., a large pizza).

Card 200 may be Wi-Fi enabled. Accordingly, for example, card 200 may access internet-based authorization servers in order to settle a coupon's payment price against an account that may be associated with card 200. A user of card 200 may, for example, press button 208 to complete the coupon purchase transaction. In so doing, a coupon's purchase price may be deducted from an account (e.g., a debit account) that may be associated with card 200. The purchased coupon may then be stored within card 200 for future use. Accordingly, for example, a user of card 200 may redeem the purchased coupon and may receive the discount on the user's next account statement (e.g., the user's checking account balance may be increased after the coupon is redeemed, after the coupon company and the merchant reconcile, and after the user's account reconciles at month's end).

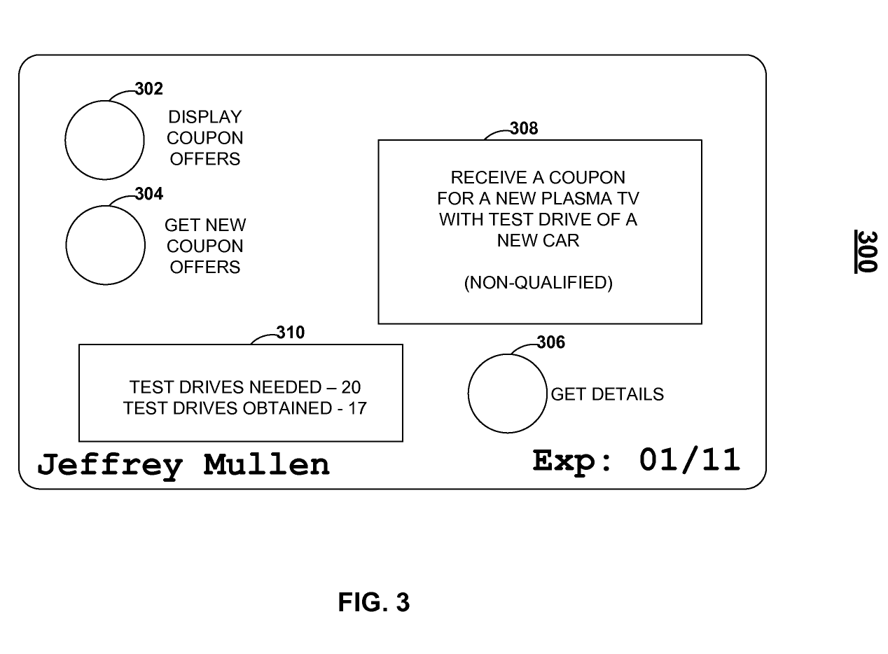

FIG. 3 shows card 300. Card 300 may include a mobility device (e.g., a Wi-Fi device), one or more buttons 302-306 and displays 308-310. A coupon offer, for example, may be provided to a user of card 300 and may be displayed by display 308. Such an offer, for example, may provide information as to whether the coupon offer may be redeemed (e.g., a qualified coupon offer) or may not yet be redeemed (e.g., a non-qualified coupon offer).

Coupon offers may, for example, be utilized as social networking tools to engage and motivate members of a group to act in response to a particular coupon offer. For example, a coupon offer may be provided in display 308 as a non-qualified coupon offer, but through interaction of members of a social networking group, may become a qualified coupon offer (e.g., a non-qualified coupon offer may become qualified if a predetermined number of members participate in a qualifying event).

The coupon offer as displayed in display 308, for example, may identify a particular coupon offer as being a non-qualified coupon offer. A user of card 300 may, for example, examine further details of the non-qualified coupon offer by, for example, pressing button 306. Such details as may be provided by display 310, for example, may include a description of a qualifying event (e.g., twenty test drives needed), which may be required to transform the coupon offer into a qualified coupon offer. Further, display 310 may provide information (e.g., seventeen test drives so far) so that a user of card 300 may determine whether the qualifying event is within reach.

Accordingly, for example, a user may determine that a qualifying event may be close at hand, which may prompt him or her to participate (e.g., take a test drive). In so doing, each person participating may help to achieve the qualifying event, thereby helping to convert a non-qualified coupon offer (e.g., nobody gets a plasma TV) into a qualified coupon offer (all twenty who took a test drive and opted into the coupon offer may now redeem the coupon for a new plasma TV).

Card 300 may store multiple coupon offers. A user of card 300 may, for example, press button 302 multiple times to cycle through each coupon offer that may be stored within card 300. Upon each depression of button 302, for example, display 308 may provide information that may be indicative of a coupon offer that may be stored within card 300. Further details of such a coupon offer may be further provided by display 310 automatically, or upon depression, for example, of button 306.

Card 300 may scan for new coupon offers. A user of card 300 may, for example, press button 304 to cause card 300 to scan for any new coupon offers that may be in existence. For example, a user of card 300 may be within a communication distance of a merchant's communication device (e.g., an RFID device) and may press button 304 to obtain any new coupon offers from the merchant. The merchant's communication device may, for example, interact with card 300 to download any and all coupon offers that may be available.

Persons skilled in the art will appreciate that card 300 may automatically query for new coupon offers. For example, card 300 may be Wi-Fi enabled, which may allow card 300 to access internet-based locations (e.g., coupon company websites, merchant websites, and email accounts) to automatically and electronically retrieve coupon offers.

Card 300 may, for example, detect a presence of a merchant device (e.g., an RFID device) that may be capable of downloading coupon offers into card 300. Card 300 may, for example, automatically retrieve coupon offers from the merchant device upon detection of such a device.

Card 300 may, for example, detect a presence of another card that may be capable of downloading coupon offers into card 300. A processor of card 300 may, for example, receive information indicative of a coupon via a touch sensitive display of card 300. Another card may, for example, include electronics that may simulate a sequence of touches or proximity of touches. In so doing, a processor of card 300 may detect such a sequence of touches using a touch sensitive display and may construe such information as information indicative of one or more coupons.

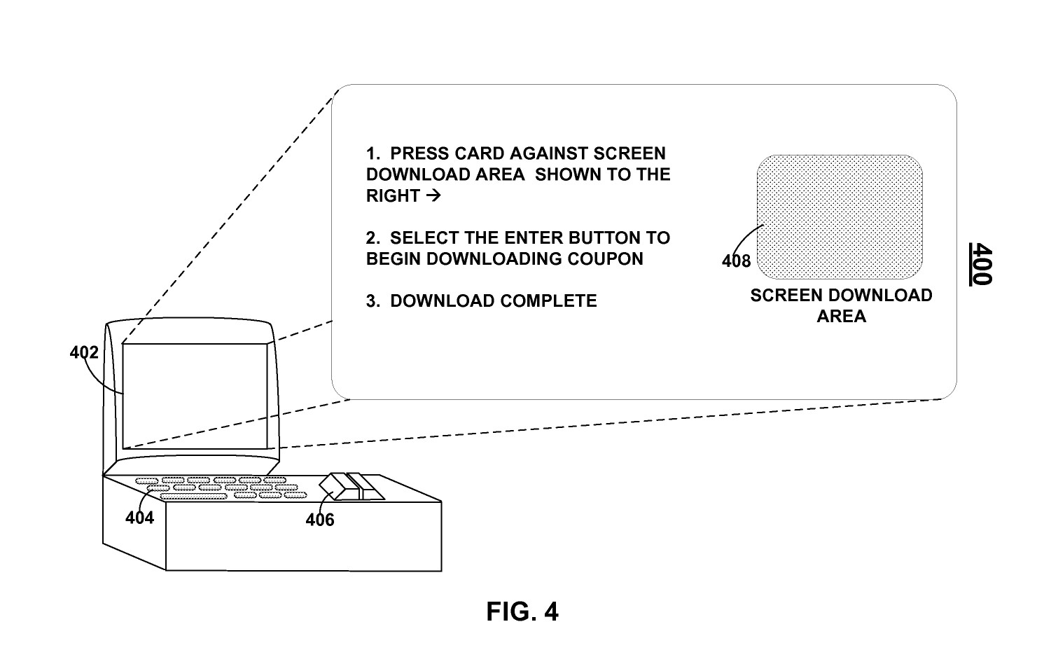

FIG. 4 shows system 400. System 400 may include a point-of-sale device utilized by a particular merchant. The point-of-sale device may include, for example, keyboard 404, magnetic stripe reader 406 and display 402. A screen download area (e.g., display portion 408) may be provided as an output device that may be used to download coupon information into a cardholder's card.

For example, a cardholder may have been alerted (e.g., via email, regular mail, internet pop-up message, or TV commercial) that a coupon is available for download. A user may, for example, visit a merchant's place of business to take possession of the coupon. The cardholder may, for example, be identified (e.g., identifying information may be entered into keyboard 404 or the cardholder's card may be swiped through magnetic stripe reader 406). The cardholder may be prompted, upon positive identification for example, to press the card against screen portion 408. The merchant's point-of-sale device may be activated (e.g., by pressing the “Enter” button of keyboard 404) and coupon information may be communicated from display 408 to the cardholder's card (e.g., by creating varying intensities and/or durations of light pulses that are construed by a processor on the cardholder's card as information that is indicative of one or more coupons).

A cardholder may, for example, be a member of a socially networked group. A cardholder may, for example, be identified as a member of the socially networked group through information contained within a card owned by the cardholder. Such identifying information may, for example, be communicated to a merchant's point-of-sale device while a transaction is being conducted, which may trigger a coupon distribution to the cardholder.

For example, a cardholder's card may be swiped through magnetic stripe reader 406 and group identifying information may be communicated (e.g., via discretionary data) to the merchant's point-of-sale device. Upon detection of the cardholder as a member of a socially networked group and/or the existence of a qualifying event (e.g., the socially networked group has a combined expenditure of a minimum dollar amount at the merchant's place of business), the merchant's point-of-sale device may indicate that a coupon is ready for distribution. Accordingly, for example, the cardholder's card may be placed against display portion 408 and the coupon may be downloaded into the cardholder's card (e.g., via flashing light generated by screen portion 408).

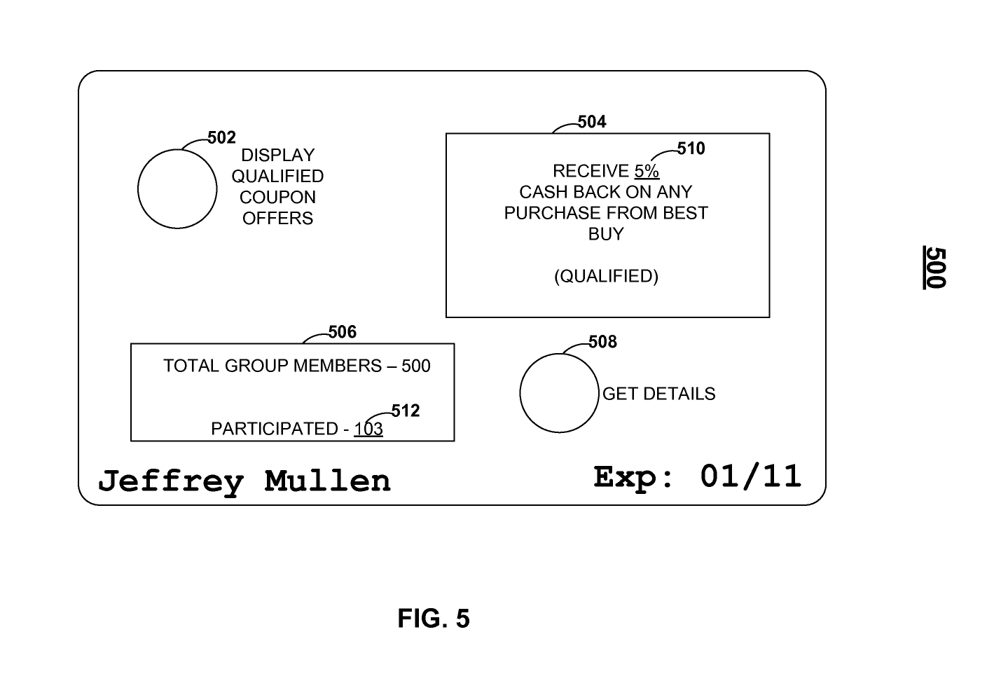

FIG. 5 shows card 500. Card 500 may, for example, include buttons 502 and 508 and displays 504 and 506. Card 500 may, for example, store a number of qualified coupon offers (e.g., coupon offers ready for redemption) that may be recalled from the memory of card 500 and displayed onto display 504 by pressing button 502. Card 500 may, for example, store details associated with the stored coupon offers and may display them automatically onto display 506. Card 500 may, for example, display stored coupon offer details only upon detection of a manual input (e.g., depression of button 508). Card 500 may, for example, detect a presence of a merchant device (e.g., an RFID device at Best Buy) that may be capable of downloading coupon offer information into card 500.

For example, a merchant (e.g., Best Buy) may track a number of members that may be associated with a particular social network. The merchant may be interested, for example, in maximizing a number of group members who purchase goods and, therefore, may provide a coupon offer through a coupon company whose efforts may maximize the number of group members who purchase goods from the merchant.

More particularly, for example, the merchant may track the number of members associated with a particular social network that purchased goods from the merchant (e.g., member count 512) and a total number of members who may be associated with the social network. Based upon a minimum number of purchasing members (e.g., 100), the merchant may wish to extend a coupon offer to all members of the social network. Accordingly, for example, the merchant may offer cash back to all group members, but only if the number of purchasing group members exceeds a minimum threshold (e.g., 100). A coupon company working in conjunction with the merchant may, for example, wish to negotiate a minimum cash back percentage (e.g., 5%) that may be offered by the merchant.

Accordingly, for example, each time a member utilizes card 500 to purchase goods from the merchant, the merchant's database may be updated with the member's information (e.g., social network group identification and total number of dollars spent). In response, the merchant may, for example, modify the coupon offer to reflect the increasing patronage.

For example, a minimum number of patronizing group members (e.g., 100) may result in a coupon offering of, for example, 5% cash back. The coupon company and the merchant may, for example, negotiate an additional 0.5% cash back for each additional 50 patronizing group members based upon the number of patronizing members that may exist at any given time. Accordingly, for example, a maximum of 9% cash back may be offered to each group member, but only if the total group membership patronizes the merchant.

Each member of the social network group, for example, may receive updates as to a status of a coupon currently being offered by the merchant. For example, a member may introduce his or her card to within a communication distance of a merchant terminal (e.g., an RFID device) to receive an update as to a number of patronizing group members to date (e.g., member count 512) and/or percentage discount 510 currently being offered by the merchant.

Accordingly, for example, non-patronizing members may be encouraged by patronizing members to transact a purchase from the merchant, so that a discount realized by a redeemed coupon may be maximized. In so doing, a redeemed value of the merchant coupon may, for example, be batch processed and settled on a deferred basis, whereby the cardholder may receive his or her cash back percentage on the cardholder's next account statement.

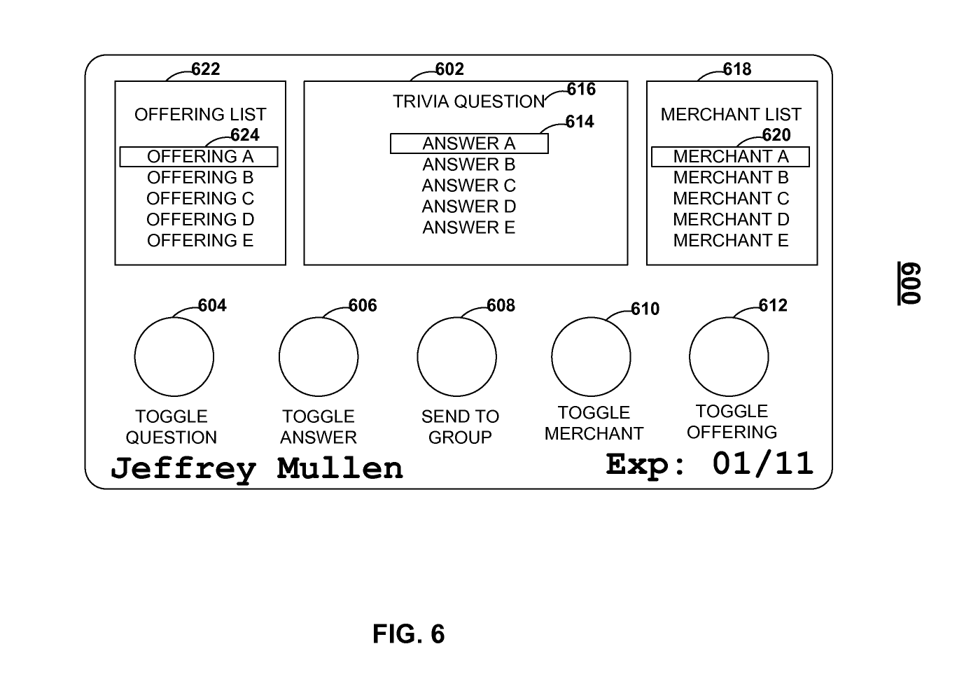

FIG. 6 shows card (e.g., mobile device) 600. Card 600 may include displays 602, 618, 622 and buttons 604-612. Card 600 may, for example, provide communications (e.g., Wi-Fi communications) to allow a user of card 600 to communicate with other members of a social group. Card 600 may, for example, provide communications to a coupon company having a list of one or more merchants who may be offering one or more coupons on a particular day.

Display 618 may, for example, display a list of one or more merchants who may be offering a particular coupon. More than one merchant may, for example, be identified by scrolling merchant identifier 620 down through a list of participating merchants using button 610. For each merchant identified by merchant identifier 620, one or more coupons may be identified by offering identifier 624 within display 622.

A selected coupon may be shared with other members of a socially networked group. For example, once a particular coupon is highlighted (e.g., by successive selections of buttons 610 and/or 612), the highlighted coupon may be shared (e.g., communicated) with other members of a group by selecting button 608.

Alternately, for example, coupons may be earned by one or more members of a group and propagated amongst the group through participation in a socially networked gaming operation. Display 602 may, for example, display a trivia question 616, which may be changed to a different trivia question via selection of button 604. Each answer of a list of answers for a corresponding trivia question may be selected by scrolling answer identifier 614 via successive selections of button 606.

The user of mobile device 600 may, for example, correctly answer the trivia question, which may then authorize the user to propagate the selected coupon amongst the remaining members of the group. The user of card 600 may, for example, incorrectly answer the trivia question, which may then deny an ability of the user to propagate the selected coupon to any of the members of the group.

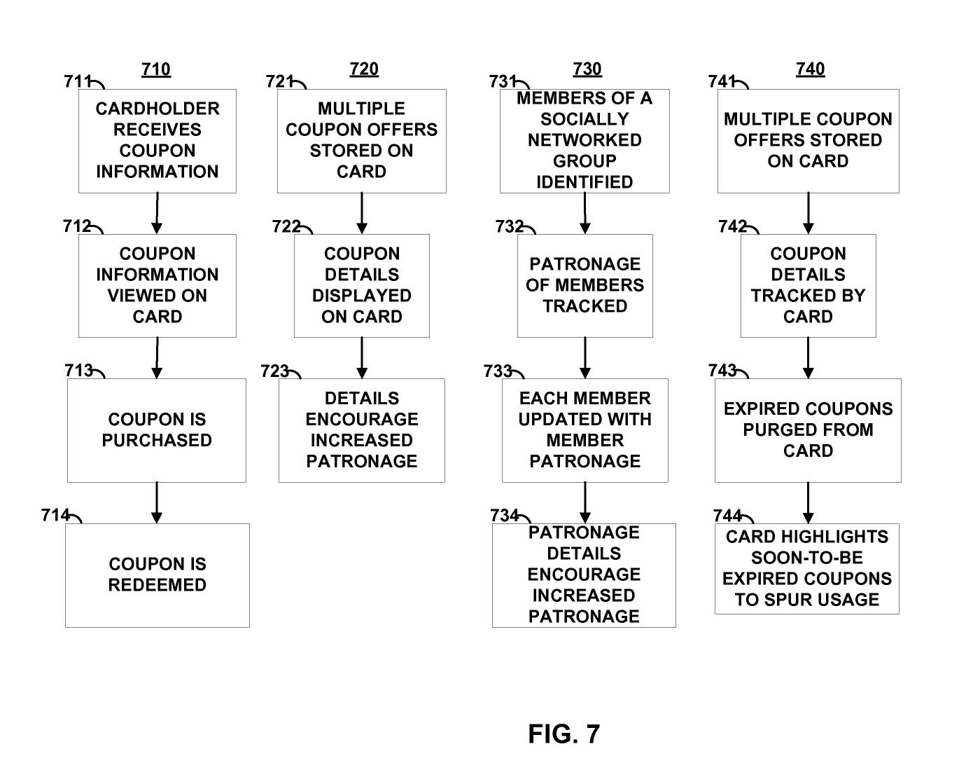

A flow diagram of process sequences is shown in FIG. 7. Step 711 of sequence 710 may include receiving coupon information. Coupon information may be received, for example, in hard copy (e.g., paper form). Alternatively, for example, a coupon may be received as an eCoupon. Coupons may, for example, be received by persons who may have previously registered with a coupon promotion and distribution scheme. Registered persons may, for example, preauthorize coupon purchases against an account (e.g., a debit or credit account) that may be associated with a cardholder's card.

Coupons may be received in any number of electronic formats. For example, eCoupons may be received via email, merchant websites, and merchant terminals (e.g., RFID terminals or download screen enabled merchant displays). Coupons may, for example, be received via a card to card transfer.

Coupons received electronically may, for example, be viewed on a card owned by a cardholder (e.g., as in step 712 of sequence 710). For example, a card may include one or more buttons and one or more displays. Pressing one button, for example, may display a coupon offer and a purchase price for the coupon offer. Pressing another button, for example, may provide authorization to purchase the displayed coupon offer (e.g., as in step 713). Pressing yet another button, for example, may reject the coupon offer and purge the coupon offer from the card's memory. Pressing yet another button, for example, may redeem a previously purchased coupon offer (e.g., as in step 714.

A coupon offer may, for example, be purchased and redeemed at the same time. For example, an unpurchased coupon offer may be displayed on a card and the card may be used during a purchase transaction. Coupon information may, for example, be communicated by the card (e.g., electromagnetically communicated via a dynamic magnetic stripe communications device that may be included on the card) along with other magnetic stripe information that may be needed to complete a particular transaction. A purchase price of the coupon may, for example, be added to the authorization message by the merchant's point-of-sale device. Credit for the redeemed coupon offer may, for example, be implemented immediately by subtracting the credit from the authorized purchase price within the authorization message. Alternately, for example, the difference between the coupon offer purchase price and redeemed value may be processed after the coupon company settles with the merchant.

Step 721 of sequence 720 may include storing one or more coupon offers on a card. Manual input (e.g., button presses) may, for example, be used to display each stored coupon offer. Other details concerning each coupon offer may, for example, be displayed on another display on a card (e.g., as in step 722). Details may, for example, be displayed upon demand (e.g., button press) or automatically (e.g., when a coupon offer is displayed, so are the related details).

Certain details relating to coupon offers may encourage increased patronage (e.g., as in step 723). For example, a coupon offer may be non-qualified (e.g., not yet available for redemption), but the related coupon offer details may reveal that qualification of the coupon offer is close at hand (e.g., the next purchase at a particular merchant's place of business qualifies the coupon offer for redemption). Accordingly, for example, a cardholder may be motivated to purchase a merchant's goods if that cardholder knew that his or her purchase would qualify a coupon offer for redemption.

Step 731 of sequence 730 may include identifying members of a socially networked group. For example, such members may, for example, be identified by an identification code contained within a member's card. Each time a member uses his or her card during a sales transaction, for example, a point-of-sale terminal may track that member's patronage (e.g., as in step 732). Likewise, patronage of other members may be tracked and each member may be updated (e.g., as in step 733) with cumulative patronage statistics (e.g., member patronage at a particular merchant's place of business may be tracked and a total amount of dollars spent by members at the merchant's place of business may be made known to each member). Accordingly, for example, statistics of member patronage may encourage increased patronage by the membership (e.g., as in step 734) since increased patronage may result in an increased value that may be provided by a particular coupon offer.

Step 741 of sequence 740 may include storing one or more coupon offers on a card. Coupon details (e.g., expiration date) may be tracked by a processor of the card (e.g., as in step 742). Upon detection of a coupon detail by the card (e.g., expiration date of a coupon has passed), coupons may be purged from a memory of the card (e.g., as in step 743). A card may, for example, anticipate expiration of a coupon stored within the card. A card may, for example, highlight the soon-to-be expired coupon (e.g., as in step 744) by, for example, displaying the soon-to-be expired coupon on a display of the card. Accordingly, for example, a user of the card may be reminded to use the coupon prior to expiration, thereby spurring usage of the coupon and increasing patronage of the participating merchant.

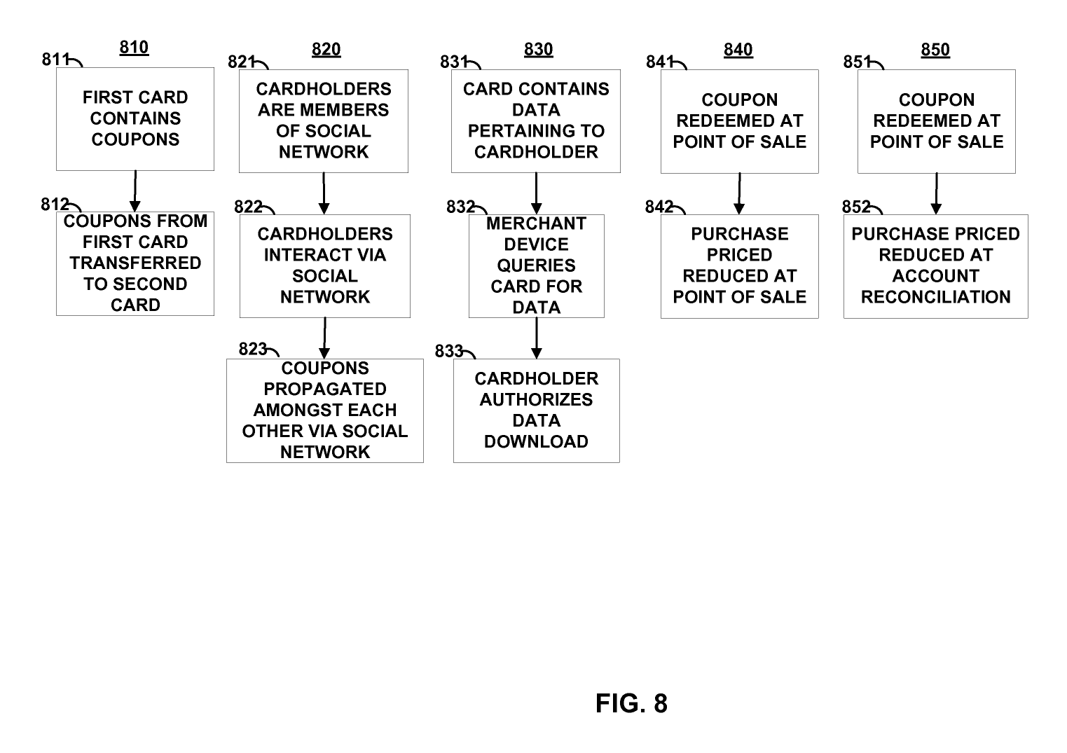

A flow diagram of process sequences is shown in FIG. 8. Step 811 of sequence 810 may include a card (e.g., mobile device) that contains coupons stored within a card's memory. A card may, for example, include a communications device (e.g., IR, RFID, touch simulator) that may be used to communicate coupon data to another card. For example, a card may include electronics that may simulate touch and another card may include, for example, a touch sensitive display. The two cards may, for example, be pressed against each other, where one of the cards simulates a series of touches and another card detects the simulated touches. The detected touches may, for example, be construed as data indicative of coupon data, thereby transferring coupon data from one card to another card (e.g., as in step 812) via a series of simulated touches and a corresponding series of touch detections.

Step 821 of sequence 820 may include two or more members of a social network. Each member may, for example, have a card (e.g., a mobile device) that may be operable to communicate (e.g., as in step 822) via a network (e.g., the internet). One member may propagate coupons (e.g., as in step 823) to one or more other members of the social network by selecting displayed coupons on the member's device for propagation to other members of the network. Alternately, for example, members may earn the right to exchange coupons amongst each other by successfully playing social games.

Step 831 of sequence 830 may include data (e.g., demographic and socio-economic data) that may pertain to the cardholder. A merchant device (e.g., a point-of-sale device) may query a cardholder's card for such information (e.g., as in step 832). A cardholder may either authorize or deny transfer of the cardholder's data by pressing a button on the card in response to the query (e.g., as in step 833).

Step 841 of sequence 840 may include a redemption of a coupon at a merchant's point-of-sale device. For example, a merchant's point-of-sale device may intercept an authorization message and immediately reduce a purchase price of the purchased goods within the authorization message (e.g., as in step 842).

Step 851 of sequence 850 may include a redemption of a coupon at a merchant's point-of-sale device. For example, a merchant's point-of-sale device may include a coupon within data transmitted to an authorization server (e.g., coupon information may be communicated within one or more discretionary data fields). A patron may, for example, realize the value of the redeemed coupon once the patron's account (e.g., a debit or credit account associated with a card) is reconciled at the end of the billing cycle of the account (e.g., as in step 852).

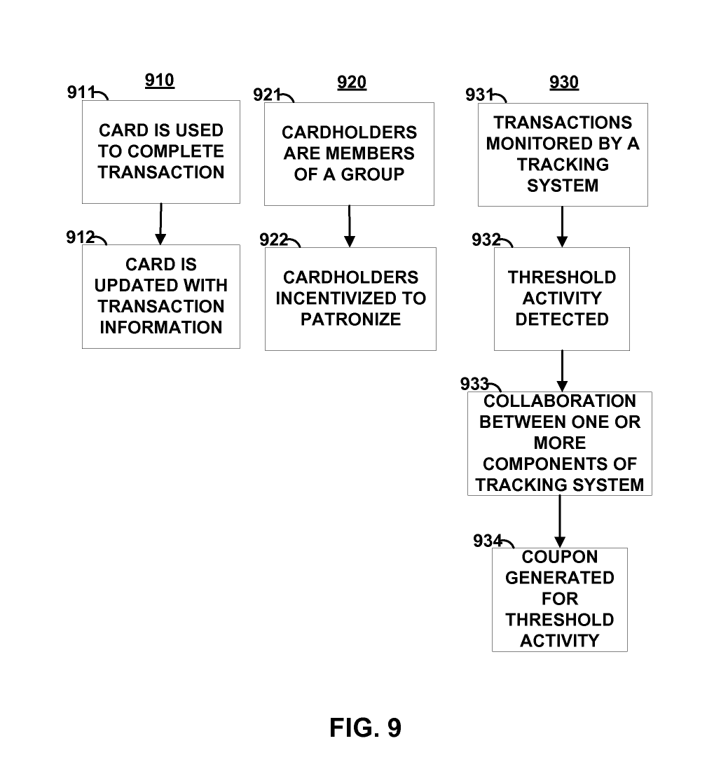

A flow diagram of process sequences is shown in FIG. 9. Step 911 of sequence 910 may include a card that may be used to complete a point-of-sale transaction at a merchant's place of business. Once the transaction is complete, the merchant's point-of-sale device may update the cardholder's card with information concerning the completed transaction (e.g., as in step 912).

For example, redemption information may be communicated to the cardholder's card that may be associated with a coupon that may have been used to complete a transaction. A particular coupon contained within a card, for example, may have been used to complete the transaction. Accordingly, for example, the spent coupon may be purged from the card's memory and made unavailable for future use. A particular coupon contained within the card, for example, may only be partially spent. Accordingly, for example, the partially spent coupon's value may be reduced by an amount used during the transaction and the reduced coupon value may be stored within the card's memory so that only the reduced coupon value may be available for future use.

Step 921 of sequence 920 may include cardholders that may, for example, belong to a group of cardholders (e.g., a socially-networked group of cardholders). Such cardholders may be incentivized to patronize a merchant or a group of merchants (e.g., as in step 922). For example, cardholders may encourage one another to patronize a particular merchant in hopes of receiving a coupon that may be redeemed at that merchant's place of business. Alternately, coupon companies (e.g., card issuers) may incentivize cardholders to pool their respective purchases at a merchant or a group of merchants.

Step 931 of sequence 930 may include transactions of one or more cardholders that may be monitored by a tracking system (e.g., a networked group of components including one or more point-of-sale devices, one or more card issuers, and one or more coupon companies). A threshold activity (e.g., a minimum dollar amount of expenditures as in step 932) may cause a collaboration between one or more components of the tracking system (e.g., as in step 933).

For example, a merchant's point-of-sale system may report to a card issuer that a purchase transaction has completed. An accumulated value of merchant sales tracked by a network entity (e.g., the card issuer) may exceed a threshold dollar amount of sales for that particular merchant. Accordingly, for example, a network entity (e.g., a coupon company) may be alerted to the threshold dollar amount and may generate one or more coupons (e.g., as in step 934) to those cardholders who, for example, contributed to the threshold dollar amount of sales for the participating merchant.

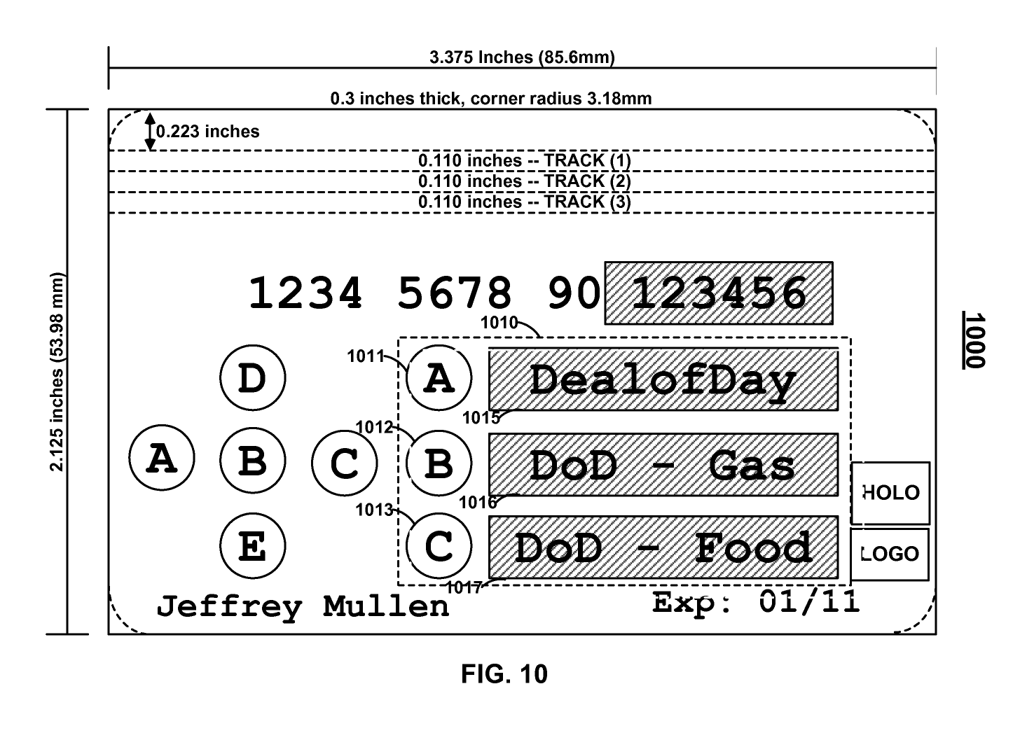

FIG. 10 shows card 1000 that may include, for example, configuration 1010. Configuration 1010 may include, for example, button 1011, button 1012, button 1013, display 1015, display 1016, and display 1017.

Button 1011 may be associated with display 1015. Button 1011 may be pressed to utilize the option described by display 1015. Button 1012 may be associated with display 1016. Button 1012 may be pressed to utilize the option described by display 1016. Button 1013 may be associated with display 1017. Button 1013 may be pressed to utilize the option described by display 1017. A card may include additional buttons or displays or may not include the number of buttons or displays of card 1000. For example, a card may include only a single button (e.g., button 1011).

Periodically, a user may be provided with a new deal of the day. A user may receive information indicative of the deal of the day on the card itself, a mobile telephonic device, or via a website. A user may communicate data from a website or mobile device to, for example, a card. For example, a user may receive an update window on a display screen of a browser or mobile phone that may blink every day. Information may be communicated to the card via this blinking. Accordingly, for example, information may be communicated to a card via light pulses. This information may include information to be displayed on a display of a card (e.g., displays 1015, 1016, and 1017) as well as information indicative of the information that should be included in a communication to a card reader should a particular button be pressed (e.g., button 1011). A user may select one or more deals of the day from a list of deals of the day and may communicate these selections to a card. A remote processor may link the selected deals of the day to particular buttons of a card (e.g., particular information received by a card reader when particular buttons are pressed by a card) such that information regarding the user's selections is not needed, for example, to be communicated to a card.

Button 1011 may be associated with a deal of the day that may provide, for example, a coupon for a particular merchant (e.g., Walmart), type of merchant (e.g., grocery store), group of merchants (e.g., Southwest and Airtran), and/or any other type of qualification. The coupon may be a discount for an overall purchase (e.g., any gas station purchase), a type of purchase (e.g., any type of gas from a gas station), or a particular item (e.g., large cup of de-caffeinated coffee from the gas station). A deal of the day may expire within a particular amount of time (e.g., by the end of the day). A deal of the day may be a one-time use or multi-time use deal within that time period. A deal of the day, for example, may include a set dollar amount off a product or purchase or a percentage discount off a product or purchase.

A deal may require that multiple people utilize the deal before the deal is activated and settled. For example, a deal may require a certain number of people (e.g., more than 1,000) utilize the deal for people to obtain the benefits of the deal. The benefits of the deal may be, for example, provided to a user after a transaction has completed and settled and may be applied to a user's card statement (e.g., credit card statement) after the purchase has been completed if the requirements of the deal have been met.

A deal of the day may require a user to purchase the deal of the day. A deal of the day may be purchased with any purchase or only at the purchase of a merchant associated with the redemption of the deal of the day. Accordingly, a user may press a deal of the day button at any merchant store to purchase the deal and then may have the remainder of the day to utilize the deal of the day at the appropriate merchant's store else lose the deal of the day.

Persons skilled in the art will appreciate that a deal of the day is not, for example, limited to a day. A deal of the day may last for any period and may not, for example, expire until the deal is redeemed. Similarly, a deal of the day may be issued at any periodicity and may last, for example, for any duration (e.g., may never expire).

Multiple deals may be provided on a card. For example, deals may be provided for different types of merchants or merchant categories. A user may receive the ability to purchase and/or redeem deals from multiple deals. For example, a user may select to receive deals associated with gas and food. The user may then receive deals for those merchant categories (e.g., each day). The user may change the merchant categories and the change may take effect after a period of time (e.g., for the next day). For example, button 1012 may be provided to allow a user to purchase and/or redeem a deal associated with gas merchants. Button 1013 may be included to allow a user to purchase and/or redeem a deal associated with food merchants.

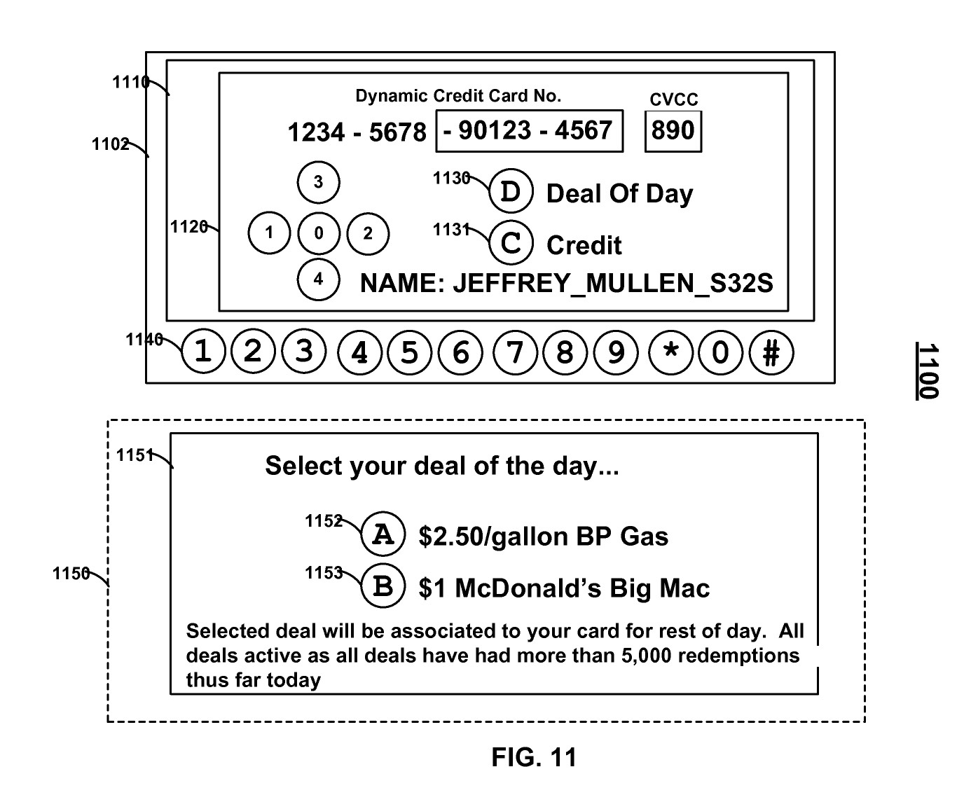

FIG. 11 shows device 1100 that may be, for example, a mobile telephonic device such as a mobile cellular phone. Any card provided herein may be provided as a virtual card on device 1100. Mechanical buttons 1140 may be utilized by a user to make selections (e.g., selections associated with a virtual card). Virtual buttons may be included that a user can activate (e.g., by utilizing a touch-screen displaying a virtual card) so that the user can make selections associated with the virtual card. Device 1100 may include, for example, housing 1102, display 1110, virtual card 1120, and virtual buttons 1130 and 1131.

Device 1100 may communicate to a card reader via electromagnetic signals (e.g., RF signals). Virtual button 1130 may be associated with a deal of the day. Button 1131 may be associated with using a particular payment card account (e.g., credit, debit, or pre-paid account).

Display configuration 1150 may be provided and may be displayed, for example, on a wireless device such as a wireless telephonic device or a wireless payment card. Configuration 1150 may include graphical user interface 1151 that may include, for example, virtual button 1152 and virtual button 1153. A user may be provided with the option of selecting, each day (or other interval), a deal for that day (or other interval). A user may perform a selection by pressing the virtual button associated with the selection. Information associated with the selection may be provided, for example, to a remote server (e.g., via a telephonic data communication) and/or a card (e.g., via light and/or sound pulses). A user may select a button on a physical card that is labeled as, for example, a “deal” button. Information indicative of that selection may then be communicated from the card to a card reader (e.g., via magnetic stripe data or RFID data) and then provided to a remote server. The remote server may then determine the deal that the user previously selected and initiate processing of that deal. Processing of a particular deal may be, for example, applying a discount on an account statement associated with an account utilized to complete a purchase associated with the deal (e.g., credit card statement).

Persons skilled in the art will appreciate that the present invention is not limited to only the embodiments described. Instead, the present invention more generally involves dynamic information and the exchange thereof. Persons skilled in the art will also appreciate that the apparatus of the present invention may be implemented in other ways than those described herein. All such modifications are within the scope of the present invention, which is limited only by the claims that follow.

What is claimed is:

1. A method, comprising:
receiving a coupon on a payment card;
storing said coupon on said payment card;
pressing a first button on said card to purchase said coupon; and
redeeming said coupon.

2. The method of claim 1, wherein a second button on said card is pressed to provide said redeeming.

3. The method of claim 1, wherein said redeeming further comprises communicating information from a communications device on said card to a payment terminal.

4. The method of claim 1, further comprising displaying said coupon on a display of said card.

5. The method of claim 1, wherein said redeeming further comprises communicating information associated with said coupon from said card to an external device.

6. The method of claim 1, wherein said redeeming further comprises communicating first information, associated with said coupon, to an external device and communicating second information, associated with a payment card number of said card, to said external device.

7. The method of claim 1, wherein said first button is a touch button.

8. A method, comprising:
receiving data from a payment card that includes first information associated with a payment account and second information associated with a deal, wherein said second information was provided in said data as a result of manual input provided into said payment card;
locating said deal from a plurality of deals;
completing a purchase transaction based, at least in part, on said first information; and
completing a deal redemption based, at least in part, on said second information.

9. The method of claim 8, wherein said deal is a time-sensitive periodic deal.

10. The method of claim 8, wherein said data is received by a payment card reader.

11. The method of claim 8, wherein said data is received by a remote server.

12. The method of claim 8, wherein said deal is located by a remote server.

13. The method of claim 8, further comprising providing said data from a magnetic stripe communications device on said payment card.

13. The method of claim 8, further comprising providing said data from an RF-based communications device on said payment card.

14. The method of claim 8, further comprising providing said data from an IC chip on said payment card.

15. A system comprising:
a payment device comprising:
a communications device for providing stored data that includes first information associated with a payment account and second information associated with a deal;
a device for receiving manual input, wherein said second information is operable to be provided in said data as a result of said manual input; and
a remote server for receiving said data and locating said deal from a plurality of deals, wherein a purchase transaction is operable to be completed based, at least in part, on said first information and a deal redemption is operable to be completed based, at least in part, on said second information.

16. The system of claim 15, wherein said payment device is a payment card.

17. The system of claim 15, wherein said payment device is a mobile telephonic phone.

18. The system of claim 15, wherein said communications device comprises an RF-based communications device.

19. The system of claim 15, wherein said communications device comprises a dynamic magnetic stripe communications device.

20. The system of claim 15, wherein said payment device further comprises a display.
